(19) United States
(12) Patent Application Publication
(10) Pub. No.: US 2026/0014477 A1
(43) Pub. Date: Jan. 15, 2026

(54) SESSION SCHEDULER

(71) Applicant: Sony Interactive Entertainment Inc., Tokyo (JP)

(72) Inventor: Bryce Botorowicz, San Mateo, CA (US)

(21) Appl. No.: 18/767,879

(22) Filed: Jul. 9, 2024

(51) Int. Cl. A63F 13/67; A63F 13/5375

(52) U.S. Cl. CPC A63F 13/67; A63F 13/5375

(57) ABSTRACT

Methods and systems are disclosed for providing suggestions for playing a video game in response to receiving a request specifying an intent and time frame that the user can spare for gameplay. Details included in the gameplay history is used to identify tasks in one or more video games that match the intent and where the gameplay was paused during a prior gameplay session. The one or more video games is returned to the user for user selection and gameplay.

### BACKGROUND OF THE INVENTION

### 1. Field of the Invention

The present disclosure relates to assisting a user in playing a video game, and more specifically, providing options of games with activities that match an intent of the user, for user selection and play.

### 2. Description of the Related Art

Video gaming industry has grown in popularity and represents a large percentage of the entertainment market and interactive content generated worldwide. Various types of video games are available for playing. There are single-player video games and multi-player video games. In the case of multi-player video games, the users can play individually against one another or can be part of a team of users playing against at least one other second team. Further, the users of the multi-player video games can be co-located or remotely located from one another. A player can select a video game for game play and provide game inputs. The game inputs are used to affect a game state of the video game and to update game data. The updated game data is used to generate game scenes that are returned to client device of the player for rendering. In the case of the multi-player video game, the game inputs of the different players are used to affect the game state and to synchronize the game data returned to the client devices associated with the different players.

Oftentimes, a user may step away from playing the video game due to other commitments. As and when time permits, the user may still be interested in returning to playing a game. When the user has very little time to spare, oftentimes due to other commitments, they may wish to maximize their time in gameplay and accomplish something significant, such as achieve a certain level, a trophy, a game object, a game token/game winnings, social gameplay with certain level or set of players, vanquish an enemy, etc., to make them feel a sense of accomplishment in the video game.

When the user has played a number of games at different times, trying to identify a specific one of the video games to play to achieve a certain challenge or progress a certain level or overcome an adversary can become increasingly difficult for the user. The user will have to remember the challenges that they faced in each of the video games that they played, the game state where they left off, specific parts of the game that they would like to re-visit or practice, the specific events or challenges that they would like to accomplish, etc. Further, each game may have its own set of inputs that need to be followed, and remembering each game-specific inputs can also become more challenging to the user, especially when they have very limited time to spare for the game.

It is in this context that embodiments of the invention arise.

### SUMMARY OF THE INVENTION

Implementations of the present disclosure relate to systems and methods for receiving an intent of the user and the time frame that the user can spare for playing the game. The intent can be a challenge that the user wants to achieve or accomplish, a level that they want to master, an adversary that wan to overcome, a game tool/game object/game winnings to capture or win, etc. Based on the expressed intent and the time the user can spare, one or more video games are identified as suggestions for the user. The video games that are identified are the ones that the user previously attempted and include actions or activities that can be attempted to accomplish the expressed intent. The identified games are then presented to the user for user selection and play. The actions or activities identified in the video games are activities that the user (i.e., a player) may have previously (i.e., prior gameplay sessions) attempted but was not successful or had not completed to achieve the intent. Alternately, the actions or activities identified to achieve the expressed intent of the user could be subsequent actions or activities that immediately follow an action or activity that the user accomplished or attempted prior to pausing the video game. In such cases, the subsequent actions or activities may be building up on the attempted action or activity to progressively accomplish the expressed intent of the user.

The systems and methods discussed herein provide intent-based suggestions of video games to the user to allow the user to achieve the intent within a limited time frame specified by the user. The intent-based suggestions are provided by tracking the progression made by the user in each of the video games attempted and played by the user. Based on the tracking, various activities attempted by the user and the status of each of the activities are identified in each video game. The system then leverages on the “time-to-complete” (i.e., the time frame that the user has specified as available for gameplay) information for the activities from the game logic of the video games and matching the leveraged information with the intent to identify specific activities in the one or more video games for suggesting to the user. The matching is done by analyzing prior gameplay data of the user to determine how close the user had come to beating a particular challenge, earning a trophy, achieving a particular level, how successful their gameplay collaboration with friends or other players was, which activities or actions the user is likely to accomplish within the limited time frame specified by the user, etc. In addition to analyzing prior gameplay data of the user, the system and method also determine the availability of instances of the video games to the user for gameplay during the specified limited time frame, the recency of gameplay of the different video games, amount of time spent by the user in each of the different video games, etc., to prioritize the selection of video games for presenting to the user for selection and play, to achieve the intent expressed by the user. User’s selection of any of the presented video games leads to an instantiation of an instance of the selected video game for gameplay of the user.

User selection of anyone of the video games provided in the suggestion causes automatic execution of an instance of the selected video game to allow the user to resume gameplay of the video game from a resumption point where the user paused during a prior gameplay session and complete the activity that corresponds with the intent of the user. The resumption point could be the point that corresponds with the activity that satisfies the intent. The selected list of video games provides the user with the freedom of choosing an activity that they want to attempt within the reduced or fragmented amount of time specified by the user to give them a sense of achievement and the gratification of playing, whether it is social gratification by playing with a select one or more of other users, gratification of achieving a level or chapter or challenge, etc.

In one implementation, a method for providing suggestions for gameplay to a user, is disclosed. The method includes receiving a request from the user. The request identifies an intent the user is seeking during the gameplay and a time frame available for achieving the intent. In response to receiving the request, gameplay history maintained for the user is analyzed to obtain details of gameplay for each video game played by the user over time. The gameplay history tracks progress of each task occurring within each video game and provides a current game state of each video game, wherein each task is associated with a distinct intent. Select ones of the plurality of video games played by the user are identified by matching the intent with a corresponding task within the video game that the user can attempt to accomplish the intent within the time frame specified in the request. The select ones of the video games are forwarded to a client device of the user for presenting in a user interface rendered on a display screen returned for rendering on a display screen of a client device for user selection. Selection of a video game at the user interface is detected, and an instance of the video game is made available to the user for the time frame to allow the user to resume gameplay of the activity within the video game in order to accomplish the intent.

In another implementation, a method for providing suggestions for gameplay to a user, is disclosed. The method includes receiving a request from the user. The request expresses an intent the user is seeking during gameplay of the video game. Select ones of a plurality of video games played by the user over time are identified, wherein the identified select ones of the video games are identified to include a task that matches with the intent expressed by the user. The select ones of the video games are presented for user selection for gameplay to allow the user to achieve their intent. In response to selection of a video game from the select ones by the user, an instance of the video game is assigned to the user for gameplay. The instance of the video game assigned to the user is set to resume gameplay from the task associated with the intent. The gameplay of the user for the selected video game is monitored and progress made in the video game during gameplay is updated to the gameplay history maintained for the user.

Other aspects of the present disclosure will become apparent from the following detailed description, taken in conjunction with the accompanying drawings, illustrating by way of example the principles of embodiments described in the present disclosure.

### BRIEF DESCRIPTION OF THE DRAWINGS

The disclosure may be better understood by reference to the following description taken in conjunction with the accompanying drawings.

FIG. 1 represents a simplified block diagram of a system that is used to provide suggestions for playing a video game to a user, in accordance with one implementation.

FIG. 2 identifies sub-modules of a session scheduler module executing on a server of a computing system and used for identifying a subset of video games with activities that correspond with an intent specified by a user, in accordance with one implementation.

FIG. 3 illustrates details of data flow using the different sub-modules of the session scheduler for generating a list of video games with activities to satisfy an intent of a user, in accordance with one implementation.

FIG. 4 illustrates a sample user interface used for rendering query prompts and for receiving responses and for selecting and interacting with a video game used having an activity that satisfies the intent, in accordance with one implementation.

FIG. 5 illustrates components of an example system that can be used to process requests from a user, provide content and assistance to the user to perform aspects of the various implementations of the present disclosure.

### DETAILED DESCRIPTION

Broadly speaking, implementations of the present disclosure include systems and methods for providing suggestions to a user for playing a video game. The suggestions are provided based on an intent the user wants to achieve during gameplay within a time frame. The intent and the time frame are expressed in a request initiated by the user to a game server. The intent can identify a task that the user wants to accomplish within a video game and the time frame can identify an amount of time the user can spare to play the game to achieve/accomplish the task. The task in a video game can correspond to a challenge to overcome, an adversary to defeat, a game level to achieve, a game object to capture, etc. The tasks can be achieved by performing certain actions or activities within the game using inputs provided via an input device (e.g., controller) or input interface. In response to receiving the request, the system analyzes prior gameplay data of the various video games played by the user to determine which ones of the plurality of games has an incomplete or a partially completed or an un-attempted task that corresponds with the intent expressed by the user. Based on the analysis, a select ones of video games that the user had previously played are identified and presented as suggestions on a user interface returned to a client device for user selection and play. Each of the select ones of video games is identified to include a task that aligns with the intent expressed by the user, wherein the task is one that is incomplete or partially complete or not yet attempted by the user. The suggestions are prioritized based on amount of task still left to be completed and the likelihood of the user completing the task associated with the intent. The likelihood of completion of the task is based on game skills exhibited by the user in each video game.

In general, the user provides inputs during gameplay of a video game, wherein the inputs are used to perform an action or an activity that is directed toward completing a task in the video game. In addition to the time taken, the suggestions can also be prioritized based on the recency of gameplay of each of the video game by the user, the game state of the video game, and video game preferences of the user, to name a few. For instance, the user may prefer video game 1 over video game 2 even though the user is closer to accomplishing a task corresponding to the intent in video game 2. In such cases, the system can prioritize the task of video game 1 over a task in video game 2, when providing the suggestions to the user. User selection of a video game from the suggested list of video games is detected by the system and, in response, an instance of the selected video game is made available to the user to allow the user to resume gameplay from a point where the user paused in prior gameplay session.

The system thus uses the gameplay data maintained in gameplay history for a plurality of games played by the user over time, the user profile of the user maintained in user profile data, event or task related data extracted from storyline of each video game played by the user to intelligently determine which video games have tasks that align with the intent of the user and the likelihood of the user, based on the user’s gameplay skills, in completing the task within the time frame that user can spare for gameplay. The selected video games matching the intent are prioritized in accordance to the user’s video game preference, recency of gameplay of the different video games, likelihood of the user in completing the tasks, to name a few, and presented on a user interface for user selection and gameplay. The user can select any one of the video games suggested by the system and attempt to complete the task associated with the intent in the time frame. The system thus allows the user to have a sense of accomplishment with the limited time they have by matching their intent with video games with associated tasks that the user can attempt and complete. User selection of the video game is detected, game play of the selected video game instantiated and made available to the user for gameplay, and game progress made by the user is monitored. The progress made by the user is used to provide a visual indication of the user’s progress in the selected video game, update the game data, and dynamically provide alternate suggestions to the user, when it is determined that the amount of progress made by the user will not be sufficient to complete the task in the specified time frame.

With the general understanding of the disclosure, specific implementations of the disclosure will now be described in greater detail with reference to the various figures. It should be noted that various implementations of the present disclosure can be practiced without some or all of the specific details. In other instances, well known process operations have not been described in detail in order not to unnecessarily obscure various embodiments of the present disclosure.

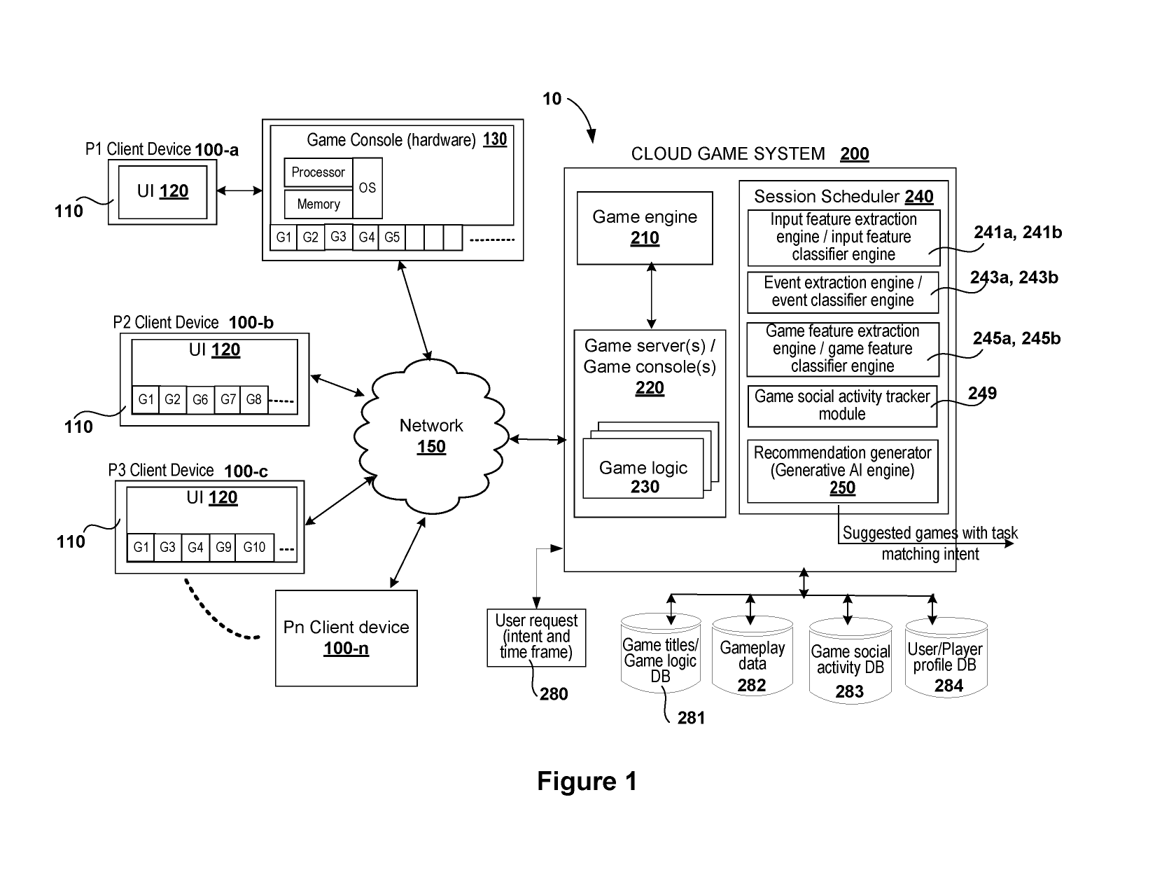

FIG. 1 represents a simplified block diagram of a system 10 having a session scheduler 240, which engages machine learning algorithm to generate and train one or more artificial intelligence (AI) models to analyze inputs provided by the user during prior gameplay sessions of a plurality of video games the user played over time, tasks occurring in each video game, gameplay skills exhibited by the user in different video games and use the results of the analysis to identify tasks within different video games that can satisfy an intent expressed by the user. A list of select ones of the video games with tasks that can satisfy the intent of the user is generated and forwarded to a client device for presenting to the user for user selection and gameplay.

The system 10 is shown as a network enabled gaming system that provides access to a plurality of video games, over a network 150, for a plurality of users. In some implementations, the system 10 includes a cloud game system 200 that can be accessed by a plurality of client devices 100 (100-a, 100-b, 100-c, … 100-n) of users over the network 150 for playing or spectating one or more video games. Various types of client devices 100 can be used to access the video games on the system 10 for gameplay and/or spectating, wherein each of the client devices 100 are configured to communicatively connect to the cloud game system 200 over the network 150. In some implementations, the client devices 100 (e.g., 100-b, 100-c, … 100-n) are networked devices that are capable of establishing direct connections to the cloud game system 200 via the network 150, such as the Internet. In some implementations, the client devices 100 can be a laptop computer, a desktop computer, a tablet or other mobile computing device, a mobile phone, etc., each of which is a networked device. For example, user P2 can use the client device 100-b to access and play video games G1, G2, G6, G7, G8, etc., user P3 can use the client device 100-c to access and play video games G1, G3, G4, G9, G10, etc, and so on.

In some other implementations, one or more client devices (e.g., 100-a) can be local devices that are configured to access a plurality of video games (e.g., G1, G2, G3, G4, G5, etc.) executing on a local game console 130. In such cases the video games can be online games executing locally on game consoles and shared locally with client devices communicatively connected to the local game console 130. The game console 130 includes a processor, memory, and operating system that are used to execute the plurality of video games locally and provide game content reflective of current game state to the client devices 100 for rendering and for further interaction. In some implementations, the game console 130 is a networked device. In some implementations, the client device 100-a accesses a video game executing on the game console 130 for gameplay and the game content representing current game state of the video game is returned to the client device 100-a for rendering and is also forwarded to the cloud game system 200 for updating the game state of the video game on the server 220. The updated game state on the server is shared with client devices (e.g., 100-b, 100-c, etc.) of other users. In some implementations, a portion of a video game is executed on the game console 130 that is local to the client device 100-a and the remaining portion of the video game is executed on a server 220 of the cloud game system 200. In such implementations, the video game is a streaming video game and the game state of the video game is synchronized between the game console 130 and the server 220 executing the video game. The synchronized game state is then shared with client devices of the user and other users. Each of the client devices 100 is associated with a display screen 110 for rendering a user interface 120 used to access various interactive applications including video games.

The cloud game system 200 includes a game engine 210, a plurality of game servers/game consoles 220, and a session scheduler 240, to name a few. The game engine 210 is used to provide the reusable resources for different video games. The plurality of game servers/game consoles 220 are configured to execute game logic 230 of different video games. The plurality of game servers/game consoles 220 can be part of a single data center or can be part of a plurality of data centers spread geographically across a wide area, as part of a wide area network. In some implementations, multiple instances of a video game can be instantiated on a single server or a plurality of servers within a single data center or across multiple data centers that are part of the cloud game system 200.

The session scheduler 240 is also available for execution at one or more servers 220 (e.g., game server or other server) of the cloud game system 200. A request including an intent that the user would like to achieve in a video game and time frame that the user is able to spare for gameplay of the video game, is initiated by a user at a client device 100 and is received by the session scheduler 240 executing at one of the servers 220 of the cloud game system 200. The request 280 is received and interpreted by the session scheduler 240 to understand the intent included in the request and the time frame (i.e., period of time) that the user can spare for gameplay. Responsive to receiving the request, the session scheduler 240 extracts from a gameplay datastore 282 gameplay data for the different video games previously played by the user and analyzes the gameplay data using feature extraction engine 241a/feature classifier engine 241b to identify the game state of the video game, resumption point (i.e., point where the user paused or suspended their gameplay in the video game), status of different tasks identified in the video game, tasks the user attempted, number of attempts, result of each attempt, etc. Each task is associated with an intent. In some cases, a single task can be associated with multiple intents. In alternate cases, multiple tasks can be associated with a single intent. This might be especially the case where the same task can be presented in multiple levels of a game with each level providing its own complexity for achieving the task. The results of the analysis are used to identify tasks that match the intent expressed by the user.

The session scheduler 240 also queries the user profile database 284 to obtain the user profile of the user. The user profile data is analyzed to determine game skills possessed by the user in each video game played by the user. Details of game skills can be used to determine if the user has the necessary skill set to attempt and successfully complete the task associated with the intent.

The session scheduler 240 also queries the game titles/game logic database 281 to obtain storyline of each video game attempted by the user. The storyline of each video game is used to identify events or tasks (or simply referred to as “tasks”) that occur in each portion of the video game as well as the intent associated with each task. As noted, each task can be associated with one or multiple intents. Consequently, the storyline is used to identify a task that matches the intent expressed by the user in the request.

In addition to retrieving the gameplay data, the storyline and the game skills of the user in each of the video games that the user has played over time, the session scheduler 240 also queries and obtains social interaction data of the user for the different video games by querying the game social activity database 283 that is maintained for the different video games. The social interaction data includes details of the other users that the requesting user prefers to play with, other users that the requesting user has mostly played with previously, social interactions of the requesting user with the other users, etc. The social interaction information can be used to provide social gratification to the user, in addition to satisfying the intent in the time frame specified in the request by the requesting user.

The session scheduler uses the feature extraction engine 241a and feature classifier engine 241b to extract features of gameplay of the user in the different video games to understand the play style of the user, the progress made by the user, the tasks that the user has attempted and not completed or partially completed, tasks the user has not attempted, etc., to build an artificial intelligence (AI) model (e.g., gameplay AI model) for each user that provides information about the gameplay of the user in different video games and the tasks that have been completed and tasks that are yet to be completed by the user in each video game. The gameplay AI model is constantly updated as and when additional gameplay data is available for the user. Similarly, the session scheduler 240 engages an event extraction engine 243a to analyze the storyline of each video game extracted from the game titles/game logic database 281 to identify the events (i.e., tasks) that occur in each portion of the video game and the intent associated with each event/task in each video game attempted by the user. The session scheduler 240 engages the game player social activity tracker module 249 to track the preferences of other users that the user wishes to play with or has previously played with or interacted with during gameplay of the different video games and the outcome of such interactions. The outcome can be a positive experience, in that the user is interested in playing or interacting with the other users in future gameplay sessions, or negative experience, in that the user experiences harassment or annoying interactions with the one or more other users resulting in the user wanting to avoid the other users during future gameplay session.

A recommendation generator 250 processes the classified features data, classified events/tasks data and the social experience of the user in the different video games to determine data-driven outcomes and probabilistic outcomes related to achieving the different tasks, and use the data related to the different tasks to generate and refine a session scheduler AI model 250a. The session scheduler AI model 250a is further refined using data related to recency of gameplay of the video game, video game preferences of the user, open or incomplete tasks associated with the different intents, etc. Outputs from the session scheduler AI model 250a are used to identify video games that have open (i.e., un-attempted task) or incomplete tasks that match the intent expressed by the user. In some implementations, the video games are identified based on likelihood the user will be able to complete the task within the time frame specified in the request, wherein the likelihood is determined from game skills that the user has gained in each video game. An output identifying the video games with open or incomplete tasks that match the intent are identified. The identified video games with the open or incomplete tasks matching the intent are used to generate a suggested list of the video games for the user to accomplish in the time frame. The suggested list is returned to the client device of the user for user selection and gameplay. It is to be noted that the suggested list includes video games that the user had previously played. In some implementations, the tasks identified in each video game that aligns with the intent are tasks that were previously attempted and not completed or partially completed or not attempted. In some cases, a task that was not attempted in a video game can be a task that immediately follows a prior task that the user has successfully completed in the video game and is a task that is associated with the intent specified by the user.

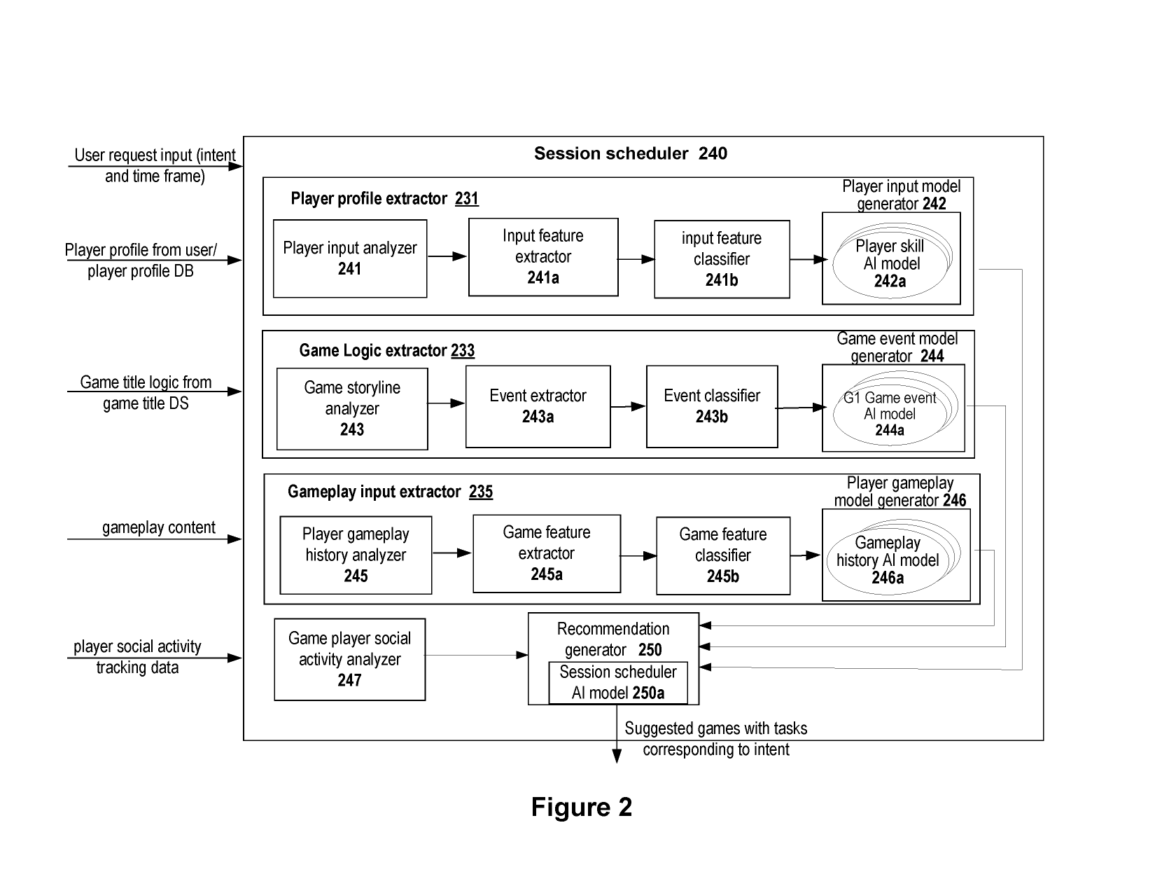

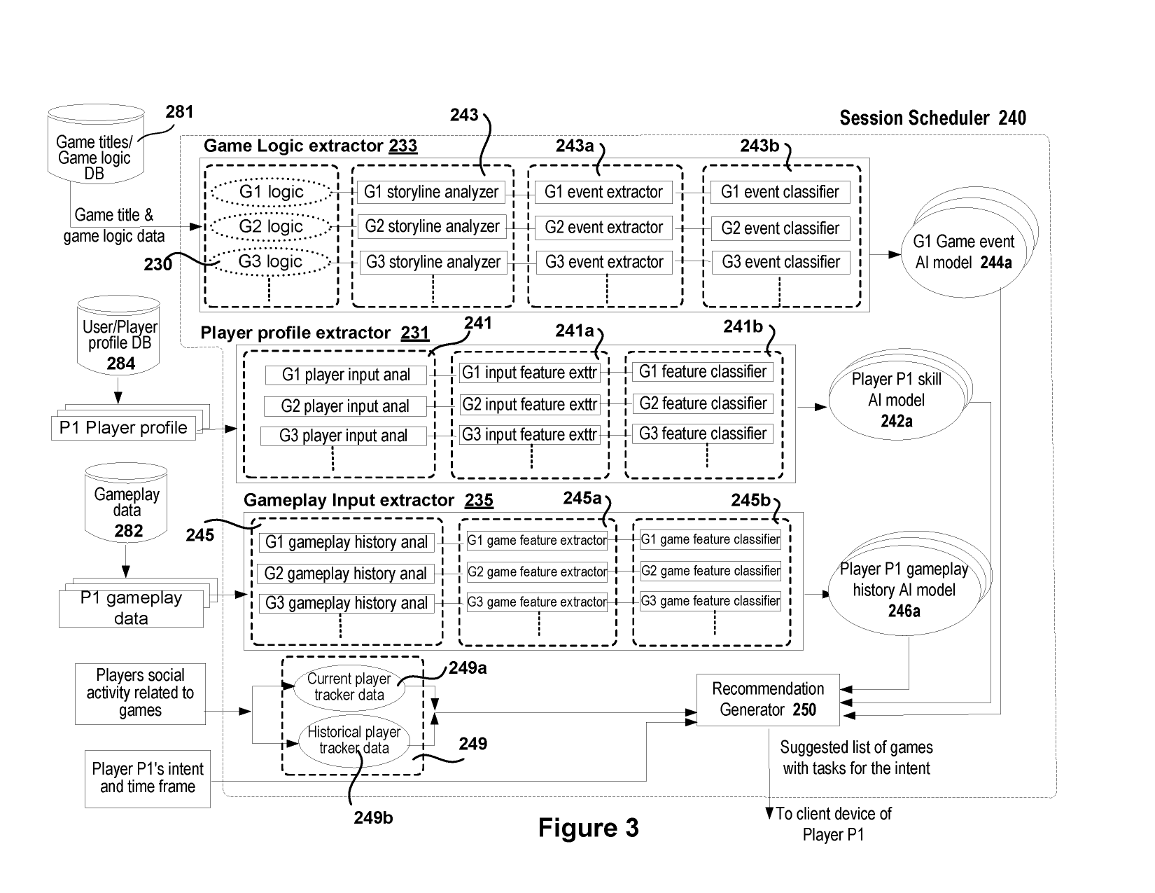

User selection of the video game from the suggested list for gameplay is detected and the gameplay of the video game is monitored by the session scheduler 240. The monitoring is done to ensure that the user is able to accomplish the task associated with the intent. As part of monitoring, during gameplay of the selected video game, when the session scheduler 240 detects the user’s lack of progress in accomplishing the task, indicating that the user is struggling to complete the task, the session scheduler 240 can intervene and proactively provide alternate suggestions of video games to select and complete in the remaining time so that the user can have a sense of accomplishment and satisfaction in the gameplay. The intent expressed by the user defines the type of satisfaction the user is seeking in gameplay of a video game within a set amount of time specified in the time frame and the session scheduler 240 is able to automatically determine the video games with tasks that can satisfy the intent. The session scheduler 240 minimizes browsing experience for the user while identifying the video games with the tasks that the user is likely to complete in the time limit established by the user. The likelihood of the user achieving the task within the time limit is guided by the game skills possessed by the user in the video game, amount or percentage of task completed and amount of task left to be completed. The game skills possessed by the user can vary from one video game to another and are based on the type of inputs required for the game and the user’s expertise (i.e., comfort level) in providing such inputs. In some implementations, when the type of inputs needed for progressing in two or more video games is the same, then the game skills possessed by the user can substantially be the same in the two or more video games. The identified games are prioritized based on the recency of gameplay of each of the video game by the user and user’s preferences of video game. Details of the role of the different sub-modules of the session scheduler 240 used to achieve a task to accomplish the intent and the processing of different data to generate a list of suggestions of video game for the expressed intent will be described in greater details with reference to FIGS. 2 and 3.

Referring to FIG. 2, the session scheduler 240 includes a plurality of sub-modules that are used to process different data generated by or for the user during prior gameplay sessions of the different video games played by the user over time, in some implementations. FIG. 2 shows the various sub-module used for processing the different data generated by or for a user (i.e., player) initiating the request that specifies the intent and the time frame for playing a video game. The various sub-modules are used for extracting and classifying various data, and for building and refining relevant AI models for the user and for each video game. Outputs from the various AI models are used by a recommendation generator 250 of the session scheduler 240 to identify one or more video games that can satisfy the user’s intent. The list of video games with tasks matching the intent are provided to the user for selection and gameplay. User selection of a video game is detected and a signal is generated from the session scheduler to a server executing an instance of the game logic of the selected video game to make the instance available (i.e., assign the instance) to the user to allow the user to resume gameplay of the video game from where they left off to allow them to achieve their intent. The gameplay resumption point can be at the point where the task that matches the intent starts or where the user paused their gameplay during prior gameplay sessions, so as to allow the user to complete the task. The user may have paused their gameplay after completing a certain percentage of the task, the percentage of completion can be anywhere between the start (i.e., 0%) and the end (100%) of the task. In some cases, the task may not even have been attempted but would have been the next step in the video game that the user would have attempted, if they had not paused in the gameplay during their prior gameplay sessions.

The session scheduler 240, broadly speaking, includes a player profile extractor 231, a game logic extractor 232, a gameplay input extractor 235, a game social activity tracker/analyzer 247 and a recommendation generator 250. The session scheduler 240, as noted, is executing on a server of a cloud game system 200 and is in communication connection with the game logics of a plurality of video games executing on the cloud game system 200. In some implementations, the server executing the session scheduler 240 can be the same server that is also executing game logic 230 of the different video games. In alternate implementations, the session scheduler 240 can be executing on a different server than the game servers 220 that are executing game logic 230 of the different video games. A request initiated by a user at a client device 100 is forwarded to the session scheduler 240. The request includes a time frame that the user can spare for playing a video game and an intent that the user wants to achieve in the video game. The intent can be associated with a task or an event or a goal or an action/activity (collectively referred to henceforth as “task”) in the video game. The user provides the intent to indicate what the user is looking for in the video game to satisfy his gameplay desire. Each video game includes a plurality of tasks that the user can achieve to progress in the video game. Each task can be associated with one or more intents. Similarly, each intent can be associated with one or more tasks. The time frame specifies a time window that the user has set aside for playing the game. The time window can include a length of time (e.g., 15 minutes or 30 minutes) that the user can spare and also specific day (e.g., Sunday or Wednesday) and/or time of day (e.g., between 1 pm to 2 pm on Wednesday or 10 pm to midnight on Sunday) that the user can spare for gameplay.

In response to receiving the request, the session scheduler 240 engages each of the plurality of sub-modules to process certain ones of the data related to gameplay of the video games and the users to identify video games with tasks that correspond with the intent. For instance, the session scheduler 240 engages a player profile extractor 231 to query user profile database 284 and obtain profile data of the user initiating the request. The user profile database 284 maintains profile data of a plurality of users (e.g., players P1, P2, P3, etc.,) who are accessing each of the plurality of video games hosted by the cloud game system 200, wherein the users can be players or spectators watching gameplay of a video game. It is noted that the user initiating the request is a player who wishes to play the video game to satisfy the expressed intent and is, therefore, alternately referred to as a “player”. The profile data of each user can be distinct for each video game that they have played or can be same for two or more video games. The profile data can be same for two or more video games when the type of inputs provided in the two or more video games are substantially similar. The profile data of the user provides detailed information related to the user’s gameplay history of the different video games that can be used to identify the video games played by the user, video games preferred by the user, and skillsets acquired by the user during gameplay of each of the plurality of video games. For instance, the profile data provides information related to all the video games the user has played over time, the game skills acquired by the user in each video game, video game preferences, length and frequency of gameplay of each video game, etc. The game skills can include the type of user inputs (speed, sequence, amount, frequency, type, etc.,) provided by the user, the ease of providing such inputs, different types of input devices used over time, preferences of input devices, etc. The game skills can be analyzed to understand the user’s input strengths, weaknesses, device preferences, type of inputs that the user is comfortable with, etc.

In some implementations, as and when new data is received from gameplay of the user, the profile data of the user is updated in the user profile database 284 and used to determine the game skills of the user. In some implementations, the user profile data of the user is extracted by a player profile extractor 231. The user could have played any number of the video games available at the cloud game server 220 over time and the profile data of the user will identify the user’s profile maintained for each of the video games that the user has played. An player input analyzer 241 is used to analyze the extracted profile data of the user to identify various profile features. The profile features that are identified from the profile data of the user can include, but not limited to, video game identifier of the different video games played by the user, game skills of the user acquired during gameplay of each video game (e.g., video games G1, G2, etc.), input devices used to provide inputs, types of inputs provided by the player, consistency of the different types of inputs provided by the user, etc. The identified profile features are extracted by the input feature extractor 241a and classified using the input feature classifier 241b. It should be noted that the features of the user that are extracted and classified can be distinct for each video game played by the user and are provided to a player input model generator 242 to generate and train a player skill AI model 242a. Outputs from the player skill AI model 242a can be used to summarize the game skills accumulated by the player in game G1, the user preference of game G1, the frequency of selecting game G1 for gameplay, amount of time spent playing video game G1, speed of progress made in different portions of game G1, etc. The outputs from the player skill AI model 242a are provided to a recommendation generator 250 for further processing.

The session scheduler 240 engages a game logic extractor 233 to extract the storyline of each video game played by each user and analyze the storyline to identify events or tasks or challenges that are scheduled to occur in different portions of each video game. As shown in FIG. 2, the game logic extractor 233 queries the game titles/game logic database 281 to obtain the storyline of each game. The storyline of each video game (e.g., video games G1, G2, G3, etc.,) played by each user (e.g., P1, P2, P3, etc.,) is analyzed by a game storyline analyzer 243 to identify different events/challenges/tasks (collectively referred to as “tasks”) that are defined in different portions of the video game. An event extractor 243a is used to extract details of the different tasks defined in each portion of each video game. The extracted details identify a type of task defined in each portion of the video game, one or more locations within the video game where the task occurs, game objects or game characters or type of game inputs required to accomplish the task, intent associated with the task, a length of the task, time needed to complete the task, complexity of the task, etc. The extracted features are then classified using an event classifier 243b. The classification can be done in accordance to type, location, type of inputs required, etc. The classified event data is then provided to a game event model generator 244 to generate and train a game event AI model 244a. Outputs of the game event AI model 244a define the intent associated with and game skills required to accomplish the task.

The session scheduler 240 also extracts gameplay data/content stored in gameplay datastore 282 for each video game played by the user and analyzes the gameplay content to identify current game state of each of the video games played by the user, details of actions or activities (i.e., type of inputs) of the user that has resulted in the current game state of each video game, the tasks that the user has completed, not successfully completed or partially completed, the tasks the user not yet attempted, number of attempts by the user for each task in each video game, time taken by the user for both the successful attempts and unsuccessful attempts, amount of action or activity that is still to be completed for a partially completed task, an intent associated with each task, type of inputs provided for each task, gameplay style (e.g., aggressive, defensive, offensive, etc.,) of the user, etc. A gameplay input extractor 235 is used to extract gameplay data for the user from the gameplay datastore 282. A player gameplay history analyzer 245 is used to analyze the extracted gameplay data of the user. The analysis is to determine the gameplay history of the user and game skills exhibited by the user during gameplay of each video game played by the user. A game feature extractor 245a uses the analyzed data to extract features associated with the user’s gameplay of each video game, including number of times the user selected each video game for gameplay, type of inputs provided, type and number of tasks attempted, number of successful attempts, number of unsuccessful attempts, current status of each video game, resumption point for resuming gameplay of each video game, input device used to provide the inputs, expertise level of the user in each game, etc. The current status of the video game is defined by current game state, which is determined by applying game inputs provided by the user during gameplay. The identified game features are classified using game feature classifier 245b, wherein the classification can be based on recency of gameplay of the video game, tasks completed, game state, game skills required, etc. In addition, the game features classification is done in accordance to number of instances of the video game available for gameplay, etc. The classified game feature data is provided as inputs to a player gameplay model generator 246, which uses the classified game feature data to generate and train gameplay history AI model 246a. Outputs from the gameplay history AI model 246a are used to identify video games that have tasks associated with the intent, video games in which these tasks are pending (i.e., partially completed), the percentage of tasks that have been completed and percentage of tasks that are still to be completed, etc. The outputs of the gameplay history AI model 246a is provided to the recommendation generator 250 for processing.

The session scheduler 240 also tracks the presence and status of different users in the different video games. The tracking may be done to provide suggestions of video games for the user, when the intent of the user specifies the user’s desire to have social gameplay with other users. In addition to specifying the user’s desire for social gameplay, the intent can also specify the social contacts or specific ones of the other users that the user would like to partner with (i.e., play with as part of a team (either on the same team or a different team) for gameplay and the time frame can specify the specific period that the user desires to have such social gameplay with the other users. The user may identify specific ones of the other users that the user has previously teamed up with during one or more prior gameplay sessions or social contacts that the user wants to play with for a current gameplay session. Based on such intent from the user, a game player social activity analyzer 247 is engaged by the session scheduler 240 to detect and track online presence of the different users. When the intent identifies specific ones of the other users the user wishes to team up with, then the game player social activity analyzer 247 tracks the online activities of those specific users. When the intent does not identify the other users that the user wishes to have social gameplay with, then the game player social activity analyzer 247 will track each and every one of the other users to identify select ones of the other users that may be online at the time frame specified in the request of the user. In some cases, the select ones of the other users can be selected by matching the game skills of the user with that possessed by the other users so that the gameplay can be among or between similarly skilled users. The online tracking data can be used to determine which ones of the users are currently playing one or more video games, availability of the user for playing one or more video games at the time frame specified by the user in the request that includes the intent, amount of interest expressed by the different users toward playing each video game with the user, etc. In some implementations, the tracking of other users can include not only current online presence but can also include other users who have expressed similar intent of social gameplay as the user and/or whose gameplay patterns indicate that they would be accessing the cloud game system 200 for gameplay during the time frame specified in the request by the user.

The online tracking of other users can be done to match the user’s availability with the availability of other users so that the user can engage in social gameplay of the video game. Information included in the online tracking data collected by the game player social activity analyzer 247 is provided to the recommendation generator 250 for further processing. In some implementations, the online tracking data 249 includes current player tracker data 249a as well as historical player tracker data 249b. The historical player tracker data 249b can be obtained from game social activity database 283 and used to identify which ones of the users have indicated (either directly or by analyzing their gameplay data) that they will be available for gameplay during the time frame specified by the user. The current player tracker data 249a can be used to determine which ones of the users who indicated to be available during the time frame for gameplay are available for gameplay of a video game with the user.

The recommendation generator 250 receives outputs of the various AI models and information from tracking the other users online social presence and activity, and generate its own session scheduler AI model 250a. The recommendation generator 250 uses the outputs from the player skill AI model 242a, the game event AI model 244a, the gameplay history AI model 246a, the player social activity analyzer 247 to identify games with tasks that match the user’s intent and for the time frame specified by the user. The recommendation generator 250 takes into consideration the gameplay of the user and of the other users across all the video games, the various features of gameplay of the users (the requesting user as well as the other users), the storylines across all the video games, and other relevant data, and performs matchmaking of the expressed intent with corresponding tasks in one or more video games. The matched tasks are then presented to the user for attempting and completing to allow the user to have the satisfaction of playing.

In some implementations, the various AI models (242a, 244a, 246a) are generated and trained in the background by the session scheduler 240, and the matchmaking of the intent with the associated task in different video games is done in substantial real-time, as and when the request with the intent and the time frame is received from the user. Outputs from the session scheduler AI model 250a identify video games with tasks that match the intent. The identified video games are prioritized in accordance to various factors, such as recency of gameplay of the video games, the amount of progress made in task associated with the intent in each of the identified video games, game skills possessed by the user, availability of an instance of the video game for gameplay, etc. The game skills possessed by the user can vary from one video game to another and can determine the likelihood of the user in completing the task in any of the identified video games within the time frame. In some implementations, the various features used for identifying the tasks matching the intent and for generating the list of the select ones of the video games are weighted. In some implementations, based on the information obtained from the profile of the user, the features of gameplay including the recency of gameplay of the video games, weights can be assigned to select one or all the features.

In some implementations, the weighting factor can be based on a time attribute. which can affect the skill level (i.e., gameplaying skills acquired) of the user. The time attribute can be either the recency of gameplay or time taken to complete the portion of the task that matches the intent. Consideration of the time attribute related to the recency of gameplay can be to indicate that the user’s gameplay skills for a video game can lower as more time passes since the user’s prior gameplay session of the video game. For example, video game G1 that the user played a day ago can be accorded a weighting factor of 1 for the skill level based on the time attribute, and if the same video game was played 6 months ago, then the weighting factor could be 0.7, and when the video game was played 1 year ago, then the weight factor could be 0.3, suggesting that for the same video game, the skill level of the user possibly lowers as more and more time passes since user’s last gameplay of the video game.

In some implementations, the game skills representing the skill level of the user can be broken down to individual skills and each of the individual skills is weighted. For example, the game skills can include button presses or inputs provided from an input device, dexterity, etc. Some of the game skills gained in one video game can be used in another video game, especially when the type of inputs needed or the input devices used in the two video games are similar. In some implementations, the game skills indicate the amount of recollection the user has of gameplay of each video game.

In some implementations, the weighting factor can also be driven based on amount of task left to complete in a video game. The amount of task can be weighted by itself or with other factor, such as time taken to complete the portion of the task matching the intent in each video game. For example, a first video game may have an intent matching task that is 85% complete and it took the user about 40 minutes to complete the 85% of the task. A second video game can have a corresponding task that is 50% complete, and the user took about 45 minutes to complete the 50%. A third video game can have a corresponding task that is 18% complete and it took the user about 5 minutes to complete. In this example, the session scheduler 240 can just weigh the percentage of completion (e.g., weight video game 1 higher than the other two video games) of a portion of the task, just the amount of time taken to complete the task (video game 3 higher than the other two video games), or both, in this example, to prioritize the identified video games with tasks matching the intent.

In addition to the recency of gameplay of the video game and/or the percentage of task completed, the weighting factor can also be driven by personal preferences of video games of the user, the availability of the video games for gameplay at the time frame specified by the user, how close the user is in completing the task, or any other profile feature or gameplay feature that is being considered to generate the intent-based suggestions of video games with tasks matching the intent. For example, matching the intent with a corresponding task within a video game can include determining an amount of task (i.e., percentage of task) that was completed by the user during a prior gameplay session (e.g., last gameplay session), amount of time taken by the user to complete the amount/percentage of task, and estimating the amount that the user can take to complete the remaining amount/percentage of task. The estimate amount of time is then matched with the time frame specified in the request to identify the video game for providing as a suggestion to the user. The profile and gameplay features are constantly refined based on the gameplay of the user in the plurality of video games, as the game skills gained by the user are transferable from one video game to another video game. Based on the weighting factor, the session scheduler 240 can prioritize which video game has the task that the user is closer to completing, which video game the user is likely to complete within the time frame the user can spare, which video game the user prefers based on their frequency of selecting the video game for gameplay or based on their mastery of the gameplaying skills, and prioritize the suggestions of the identified video games. The suggested and prioritized list of video games with tasks that match the intent are forwarded to the client device of the user for rendering on a user interface displayed on a display screen of the client device of the user for user selection and gameplay. In some implementations, the video games with tasks matching the intent can be identified and suggested for tasks that can be achieved by the user as close to the time frame specified as possible. For example, for a task of game 1 that is 85% complete, it may be determined, based on the pace of the user and the game skills possessed by the user, that the user can complete the remaining 15% of the task in about 17-18 minutes but the user has specified that they have only 15 minutes to spare. In such cases, even when the task takes longer than the time frame specified by the user, game 1 may be suggested as one of the video games for the user to attempt to achieve the intent. In some implementations, game 1 may be suggested over other video games as the likelihood of the user completing the task of game 1 is closer, even when it is over the time frame, than the other video games with tasks matching the intent.

User selection of the video game from the generated list of video games with tasks matching the intent is detected by the session scheduler 240 and a signal is automatically sent to the server 220 of the cloud game system 200 executing the instance of the selected video game to provide the user with access to the instance of the video game to allow the user to gameplay at the time frame specified by the user. Alternately, the session scheduler 240 automatically sends a signal to request an instance of the video game to be spun up in time for the user to access the video game for gameplay. During current gameplay session, the recommendation generator 250 of the session scheduler 240 monitors the progress of the user in the task of the selected video game. Based on the pace at which the user is progressing in the task, the recommendation generator 250 may determine that the user will not be able to complete the task associated with the intent within the specified time frame. In some implementations, based on the pace, if the amount of progress made in the task within the selected video game falls below a predefined level, one or more alternate video games with alternate tasks to complete within the remaining time are provided as suggestions for user selection. For instance, in response to the determination that the user is progressing at a much slower pace than what was anticipated from the based on the gameplay skills, the recommendation generator 250 may update the user interface with alternate suggestions of video games for the user to attempt and complete in the left-over time. The alternate suggestions are provided in substantial real-time (i.e., during current gameplay) and such alternate suggestions are provided by analyzing not only the historical gameplay data of the user but also the current gameplay data of the user as the user is providing inputs to accomplish the task. The alternate suggestions are done by updating the user’s gameplay history, refining the various AI models (e.g., player skill AI model 242a, Game event AI model 244a, gameplay history AI model 246a) across multiple games, modeling the storyline obtained from the game logic, and blending all of these data together to respond to the original request by updating the customized list of video games generated for the user.

User selection of an alternate video game from the suggested alternate list is detected by the session scheduler, wherein the alternate video game is identified to include an alternate task that corresponds with the intent or corresponds with a distinct intent that is similar to the intent expressed in the request. In response to detecting selection of the alternate video game, the current gameplay of the video game is paused, the alternate video game selected by the user is automatically instantiated and made available to the user for gameplay, and the user is switched from the selected video game to the instance of the alternate video game to resume gameplay from a resumption point defined for the alternate video game. The resumption point is determined from prior gameplay session of the user. The user can play the alternate video game to achieve the alternate task and the gameplay data and the profile data of the user are updated to reflect the accomplishment of the alternate task by the user and the time frame in which it was accomplished.

In some implementations, as the user is playing the video game to accomplish the task, the gameplay of the user is monitored. As part of monitoring, the session scheduler 240 may provide a count-down timer for the time frame specified in the request. The count-down timer is provided to allow the user to have a visual indication of how much time has passed since the user started gameplay of the selected video game to achieve the task and how much time is left to encourage the user to complete the task. As noted previously, the task can be a task that the user previously attempted but did not complete (i.e., partially completed task) or a new task that the user has not yet attempted but is a subsequent task that matches the intent and that follows a point in the video game where the user left off during prior gameplay session.

FIG. 3 shows the various sub-modules of the session scheduler 240 processing the data for different users playing a variety of video games at the cloud game system 200. The games played by each user can be distinctly different from that of other users or some of the video games played by the other users can be common. The player profile extractor 231 retrieves profile data of each of the users (e.g., user P1, P2, P3, … Pn) that have played one or more video games available at the cloud game system 200. In some implementations, the profile data of each user is maintained separately for each video game. In alternate implementations, the profile data of each user is maintained for all the video games. The profile data of each user is processed using a corresponding player input analyzer 241 defined for each game G1, G2, G3, etc. The player input analyzer 241 includes a corresponding input feature extractor 241a to extract input features of the user in each game and a corresponding input feature classifier 241b to classify the input features of each user in each game. The classified input features are used to generate and generate a player skill AI model 242a for each player for each game.

A game logic extractor 233 is used to query game logic 230 of each game (e.g., game logic of game G1, G2, G3, etc.) available at the cloud game system 200 to obtain the storyline defined for each video game. The storyline of a video game identifies the various tasks, game objects, game characters, game challenges, game winnings, game actions, game activities, etc., defined in different portions of the video game. A game storyline analyzer 243 is defined for each video game to analyze the respective storyline of the video game to identify the various tasks, actions, activities defined in different portions of the video game. An event extractor 243a is used to extract details of each task (also referred to as events) of each game and classify the events using a corresponding event classifier 243b. The classified events are used to generate and train Game event AI model 244a for each game played by each player.

A gameplay input extractor 235 is used to analyze gameplay data of each user for each game from prior gameplay sessions and extract features of inputs provided by each user for each game. A player gameplay history analyzer 245 is used to identify the gameplay features for each of the different games played by each of the users. A game feature extractor 245a defined for each video game is used to extract the features from gameplay data generated from the inputs of the users and a corresponding game feature classifier 245b defined for each video game is used to classify the features from gameplay data of each user. Classified features of each user in each video game is used to generate and train player gameplay history AI model 246a for each player for each game.

Social activity of each user in each of the video games is analyzed to determine each user’s social activity status in each video game. The social activity status collected during gameplay of each game provides details of each user’s social activity including which other users the user interacted with, the user teamed with, who the social contacts of each user are, each user’s preference of other users for playing with or competing against, preferred time for gameplay of each video game, etc. The social activity status is determined from both current player tracker data 249a and historical player tracker data 249b. The data from all the AI models and the tracker data are used by the recommendation generator 250 to provide a list of suggested video games with tasks that match with the intent of the user.

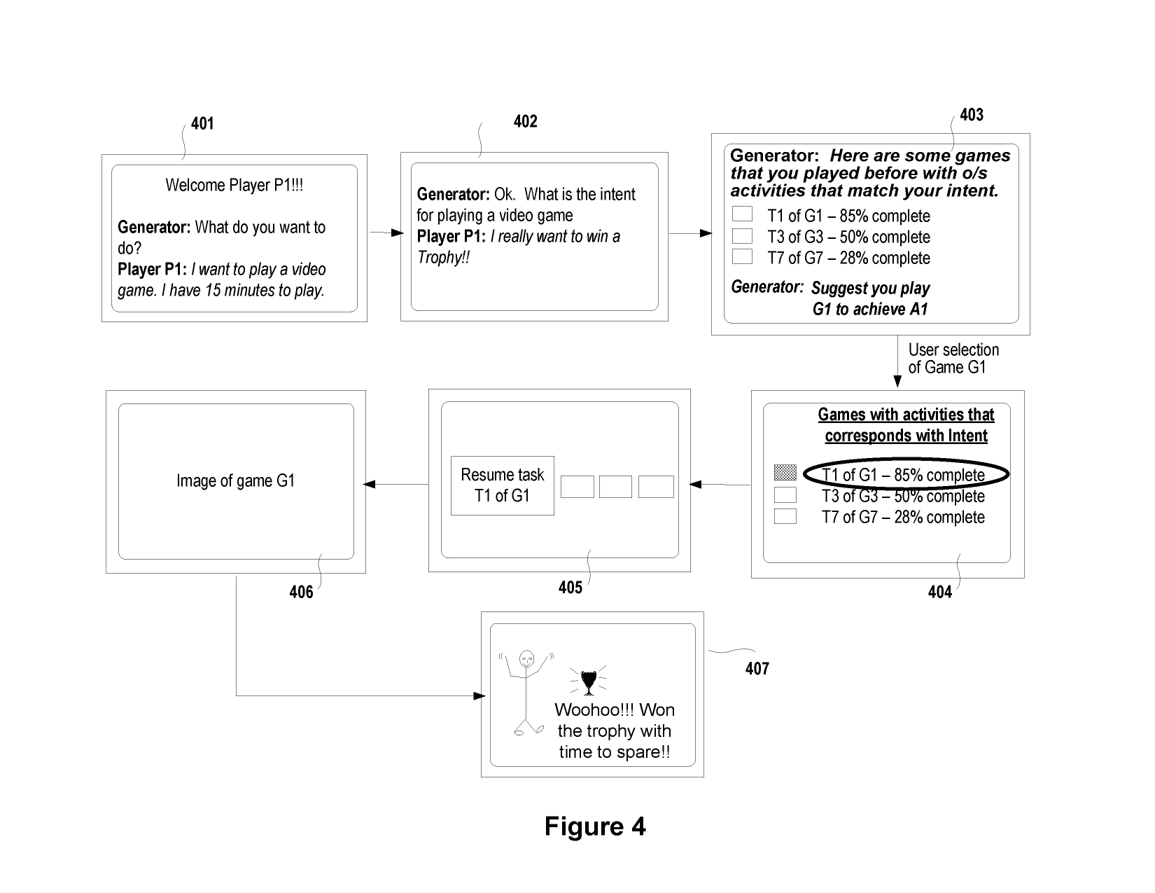

FIG. 4 illustrates a flow of a method used for providing suggestions of video games to play to satisfy an intent of a user, in some implementations. The user can access a user interface at a client device and interact to express their intent. Operation 401 shows an example of an initial interaction to a query rendered at the user interface where the user specifies the amount of time the user is able to spare for playing a video game. In some implementation, the initial query can be accompanied by a text box for specifying the time frame the user can spare for gameplay. In alternate implementations, the query can be accompanied by a rotating time wheel or a sliding timeline or an input box with an up and down arrow to specify the time frame.

In response to providing an answer to the initial query, a second query can be presented on the user interface to obtain addition information on what the intent of the user (i.e., player P1) is, as shown in operation 402. The user can respond by providing their intent. In the operation 402, the user has expressed their intent of winning a trophy. In response to receiving the intent and the time frame expressed by the user, a recommended list of video games and tasks that match the intent are identified, prioritized and forwarded to the user for rendering at the user interface for user selection and gameplay, as illustrated in operation 403. The feature used for prioritizing the video games/tasks is the percentage of completion of the respective tasks matching the intent. FIG. 4 illustrates an example of the list of tasks and games generated for the intent and prioritized for the user. The list in the example includes task 1 of game 1 with 85% completion, task 3 of game 3 with 50% completion and task 7 of game 7 with 28% completion.

User selection of the video game 1 on the user interface, as shown by the greyed selection box in operation 404, is detected by the session scheduler 240 and an instance of the video game 1 is instantiated and access provided to the user for gameplay. The access allows the user to resume gameplay of video game 1 starting at a point within task T1 where the user previously left off in the prior gameplay session, as illustrated in operation 405. As the user interacts with the video game 1 to complete the task T1, an image of game 1 is presented on the user interface rendered at the client device of the user to allow the user to provide inputs and progress in the task, as illustrated in operation 406. When the user successfully completes the task T1 (i.e., wins the trophy) associated with the intent, the user interface is updated to show an image of the user with the trophy that they won during gameplay of video game 1, as illustrated in operation 407. The process of specifying an intent and receiving suggestions of the video games that can satisfy the intent can be performed as and when the user has time to spare.

Although the various implementations are discussed with respect to completing a task to satisfy the intent, wherein the task includes an event to participate, game objects or game currencies to win, certain level to achieve, an obstacle to overcome, an adversary to defeat, etc., the implementations are not restricted to such tasks but can also be extended to cover social play (i.e., social participation/social interaction). In some implementations, the social contacts or other users are tracked online. In some implementations, a heat map may be provided to identify the other users (e.g., friends, social contacts, other users with which the user has played before, etc.) who are online during the time frame specified by the user in the request. In addition to heat map, the other users expressed intentions of being online at different times can also be used to identify the other users and to fine-tune the time frame of the user with the times the other users are intending to be online so that the time frames can overlap to allow the user to have the expressed social interaction, thereby maximizing the user’s gaming session. It should be noted that the various implementations described to include the games executing on a cloud game system 200 and the user accessing the video games on the cloud game system can be extended to include video games that are executed locally to the client device, wherein the local execution of the video games can be on a game console.

The user defines the kind of satisfaction (i.e., intent, such as winning a trophy, playing with friend(s)) they are seeking in a video game for a set period of time, and the session scheduler automatically goes through the gameplay activity of the user to determine which games the user has recently played, which games the user prefers to play, which games have tasks that align with the user’s intent, which games have tasks that align with the users time frame (i.e., which games have tasks that are likely to be completed by the user within the specified time frame based on their gameplay skills), and use the gameplay information, storyline information, game skill information (obtained from profile data of the user) to make suggestions of video games that can be automatically instantiated to allow the user to instantly jump in and play so as to have the highest chance of completing the actions/activities to accomplish the task matching the intent within the time frame or as close to the time frame specified by the user.

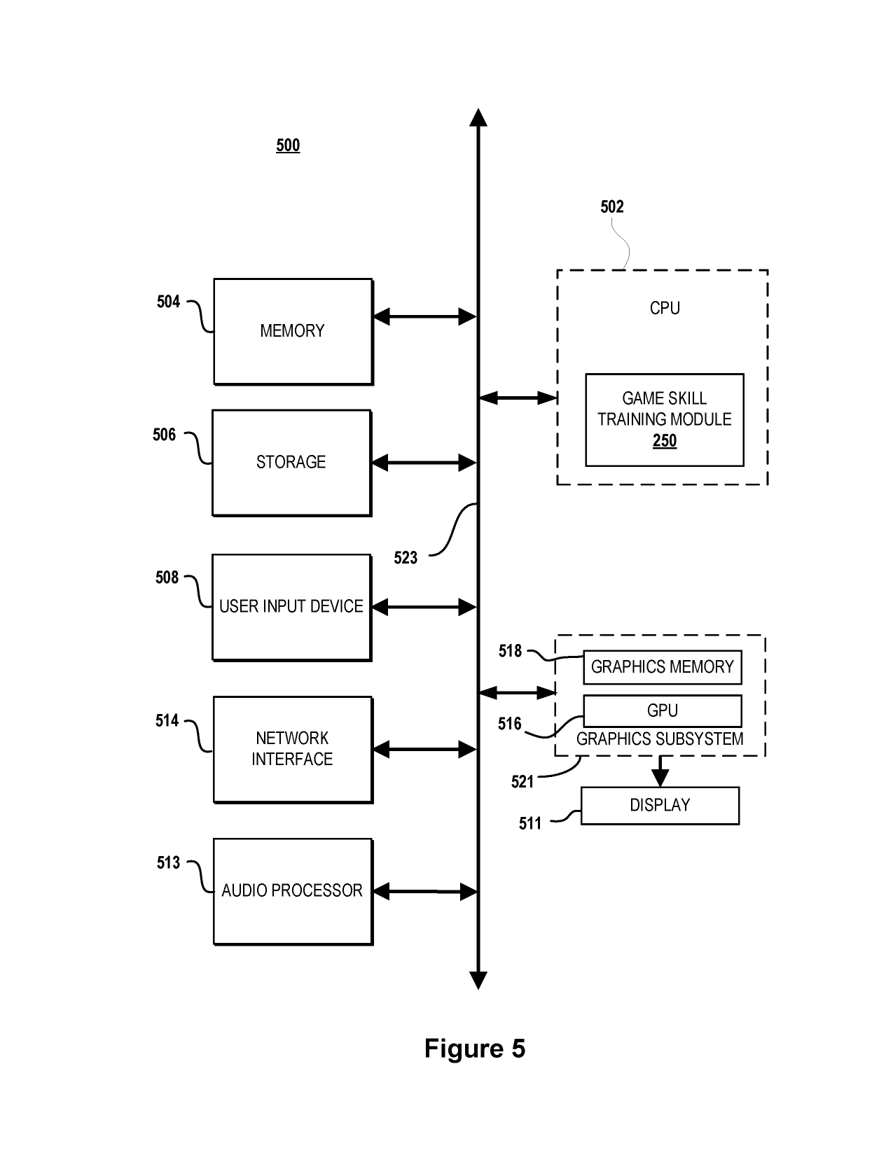

FIG. 5 illustrates components of an example device 500 (e.g., game server 220 of FIG. 1) that can be used to perform aspects of the various embodiments of the present disclosure. This block diagram illustrates a device 500 that can incorporate or can be a personal computer, video game console, personal digital assistant, a server or other digital device, suitable for practicing an embodiment of the disclosure. Device 500 includes a central processing unit (CPU) 502 for running software applications and optionally an operating system. CPU 502 may be comprised of one or more homogeneous or heterogeneous processing cores. For example, CPU 502 is one or more general-purpose microprocessors having one or more processing cores. Further embodiments can be implemented using one or more CPUs with microprocessor architectures specifically adapted for highly parallel and computationally intensive applications, such as processing operations of interpreting a query, identifying contextually relevant resources, and implementing and rendering the contextually relevant resources in a video game immediately. Device 500 may be a localized to a player playing a game segment (e.g., game console), or remote from the player (e.g., back-end server processor), or one of many servers using virtualization in a cloud game system for remote streaming of gameplay to clients.

Memory 504 stores applications and data for use by the CPU 502. Storage 506 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media. User input devices 508 communicate user inputs from one or more users to device 500, examples of which may include keyboards, mice, joysticks, touch pads, touch screens, still or video recorders/cameras, tracking devices for recognizing gestures, and/or microphones. Network interface 514 allows device 500 to communicate with other computer systems via an electronic communications network, and may include wired or wireless communication over local area networks and wide area networks such as the internet. An audio processor 513 is adapted to generate analog or digital audio output from instructions and/or data provided by the CPU 502, memory 504, and/or storage 506. The components of device 500, including CPU 502, memory 504, (data) storage 506, user input devices 508, network interface 514, and audio processor 513 are connected via one or more data buses 523.

A graphics subsystem 521 is further connected with data bus 523 and the components of the device 500. The graphics subsystem 521 includes a graphics processing unit (GPU) 516 and graphics memory 518. Graphics memory 518 includes a display memory (e.g., a frame buffer) used for storing pixel data for each pixel of an output image. Graphics memory 518 can be integrated in the same device as GPU 516, connected as a separate device with GPU 516, and/or implemented within memory 504. Pixel data can be provided to graphics memory 518 directly from the CPU 502. Alternatively, CPU 502 provides the GPU 516 with data and/or instructions defining the desired output images, from which the GPU 516 generates the pixel data of one or more output images. The data and/or instructions defining the desired output images can be stored in memory 504 and/or graphics memory 518. In an embodiment, the GPU 516 includes 3D rendering capabilities for generating pixel data for output images from instructions and data defining the geometry, lighting, shading, texturing, motion, and/or camera parameters for a scene. The GPU 516 can further include one or more programmable execution units capable of executing shader programs.

The graphics subsystem 521 periodically outputs pixel data for an image from graphics memory 518 to be displayed on display device 511. Display device 511 can be any device capable of displaying visual information in response to a signal from the device 500, including CRT, LCD, plasma, and OLED displays. Device 500 can provide the display device 511 with an analog or digital signal, for example.

It should be noted, that access services, such as providing access to games of the current embodiments, delivered over a wide geographical area often use cloud computing. Cloud computing is a style of computing in which dynamically scalable and often virtualized resources are provided as a service over the Internet. Users do not need to be an expert in the technology infrastructure in the "cloud" that supports them. Cloud computing can be divided into different services, such as Infrastructure as a Service (IaaS), Platform as a Service (PaaS), and Software as a Service (SaaS). Cloud computing services often provide common applications, such as video games, online that are accessed from a web browser, while the software and data are stored on the servers in the cloud. The term cloud is used as a metaphor for the Internet, based on how the Internet is depicted in computer network diagrams and is an abstraction for the complex infrastructure it conceals.

A game server may be used to perform the operations of the durational information platform for video game players, in some embodiments. Most video games played over the Internet operate via a connection to the game server. Typically, games use a dedicated server application that collects data from players and distributes it to other players. In other embodiments, the video game may be executed by a distributed game engine. In these embodiments, the distributed game engine may be executed on a plurality of processing entities (PEs) such that each PE executes a functional segment of a given game engine that the video game runs on. Each processing entity is seen by the game engine as simply a compute node. Game engines typically perform an array of functionally diverse operations to execute a video game application along with additional services that a user experiences. For example, game engines implement game logic, perform game calculations, physics, geometry transformations, rendering, lighting, shading, audio, as well as additional in-game or game-related services. Additional services may include, for example, messaging, social utilities, audio communication, game play replay functions, help function, etc. While game engines may sometimes be executed on an operating system virtualized by a hypervisor of a particular server, in other embodiments, the game engine itself is distributed among a plurality of processing entities, each of which may reside on different server units of a data center.

According to this embodiment, the respective processing entities for performing the operations may be a server unit, a virtual machine, or a container, depending on the needs of each game engine segment. For example, if a game engine segment is responsible for camera transformations, that particular game engine segment may be provisioned with a virtual machine associated with a graphics processing unit (GPU) since it will be doing a large number of relatively simple mathematical operations (e.g., matrix transformations). Other game engine segments that require fewer but more complex operations may be provisioned with a processing entity associated with one or more higher power central processing units (CPUs).

By distributing the game engine, the game engine is provided with elastic computing properties that are not bound by the capabilities of a physical server unit. Instead, the game engine, when needed, is provisioned with more or fewer compute nodes to meet the demands of the video game. From the perspective of the video game and a video game player, the game engine being distributed across multiple compute nodes is indistinguishable from a non-distributed game engine executed on a single processing entity, because a game engine manager or supervisor distributes the workload and integrates the results seamlessly to provide video game output components for the end user.

Users access the remote services with client devices, which include at least a CPU, a display and I/O. The client device can be a PC, a mobile phone, a netbook, a PDA, etc. In one embodiment, the network executing on the game server recognizes the type of device used by the client and adjusts the communication method employed. In other cases, client devices use a standard communications method, such as html, to access the application on the game server over the internet. It should be appreciated that a given video game or gaming application may be developed for a specific platform and a specific associated controller device. However, when such a game is made available via a cloud game system as presented herein, the user may be accessing the video game with a different controller device. For example, a game might have been developed for a game console and its associated controller, whereas the user might be accessing a cloud-based version of the game from a personal computer utilizing a keyboard and mouse. In such a scenario, the input parameter configuration can define a mapping from inputs which can be generated by the user’s available controller device (in this case, a keyboard and mouse) to inputs which are acceptable for the execution of the video game.

In another example, a user may access the cloud gaming system via a tablet computing device, a touchscreen smartphone, or other touchscreen driven device. In this case, the client device and the controller device are integrated together in the same device, with inputs being provided by way of detected touchscreen inputs/gestures. For such a device, the input parameter configuration may define particular touchscreen inputs corresponding to game inputs for the video game. For example, buttons, a directional pad, or other types of input elements might be displayed or overlaid during running of the video game to indicate locations on the touchscreen that the user can touch to generate a game input. Gestures such as swipes in particular directions or specific touch motions may also be detected as game inputs. In one embodiment, a tutorial can be provided to the user indicating how to provide input via the touchscreen for gameplay, e.g., prior to beginning gameplay of the video game, so as to acclimate the user to the operation of the controls on the touchscreen.

In some embodiments, the client device serves as the connection point for a controller device. That is, the controller device communicates via a wireless or wired connection with the client device to transmit inputs from the controller device to the client device. The client device may in turn process these inputs and then transmit input data to the cloud game server via a network (e.g., accessed via a local networking device such as a router). However, in other embodiments, the controller can itself be a networked device, with the ability to communicate inputs directly via the network to the cloud game server, without being required to communicate such inputs through the client device first. For example, the controller might connect to a local networking device (such as the aforementioned router) to send to and receive data from the cloud game server. Thus, while the client device may still be required to receive video output from the cloud-based video game and render it on a local display, input latency can be reduced by allowing the controller to send inputs directly over the network to the cloud game server, bypassing the client device.

In one embodiment, a networked controller and client device can be configured to send certain types of inputs directly from the controller to the cloud game server, and other types of inputs via the client device. For example, inputs whose detection does not depend on any additional hardware or processing apart from the controller itself can be sent directly from the controller to the cloud game server via the network, bypassing the client device. Such inputs may include button inputs, joystick inputs, embedded motion detection inputs (e.g., accelerometer, magnetometer, gyroscope), etc. However, inputs that utilize additional hardware or require processing by the client device can be sent by the client device to the cloud game server. These might include captured video or audio from the game environment that may be processed by the client device before sending to the cloud game server. Additionally, inputs from motion detection hardware of the controller might be processed by the client device in conjunction with captured video to detect the position and motion of the controller, which would subsequently be communicated by the client device to the cloud game server. It should be appreciated that the controller device in accordance with various embodiments may also receive data (e.g., feedback data) from the client device or directly from the cloud gaming server.

In one embodiment, the various technical examples can be implemented using a virtual environment via a head-mounted display (HMD). An HMD may also be referred to as a virtual reality (VR) headset. As used herein, the term “virtual reality” (VR) generally refers to user interaction with a virtual space/environment that involves viewing the virtual space through an HMD (or VR headset) in a manner that is responsive in real-time to the movements of the HMD (as controlled by the user) to provide the sensation to the user of being in the virtual space or metaverse. For example, the user may see a three-dimensional (3D) view of the virtual space when facing in a given direction, and when the user turns to a side and thereby turns the HMD likewise, then the view to that side in the virtual space is rendered on the HMD. An HMD can be worn in a manner similar to glasses, goggles, or a helmet, and is configured to display a video game or other metaverse content to the user. The HMD can provide a very immersive experience to the user by virtue of its provision of display mechanisms in close proximity to the user’s eyes. Thus, the HMD can provide display regions to each of the user’s eyes which occupy large portions or even the entirety of the field of view of the user, and may also provide viewing with three-dimensional depth and perspective.

In one embodiment, the HMD may include a gaze tracking camera that is configured to capture images of the eyes of the user while the user interacts with the VR scenes. The gaze information captured by the gaze tracking camera(s) may include information related to the gaze direction of the user and the specific virtual objects and content items in the VR scene that the user is focused on or is interested in interacting with. Accordingly, based on the gaze direction of the user, the system may detect specific virtual objects and content items that may be of potential focus to the user where the user has an interest in interacting and engaging with, e.g., game characters, game objects, game items, etc.

In some embodiments, the HMD may include an externally facing camera(s) that is configured to capture images of the real-world space of the user such as the body movements of the user and any real-world objects that may be located in the real-world space. In some embodiments, the images captured by the externally facing camera can be analyzed to determine the location/orientation of the real-world objects relative to the HMD. Using the known location/orientation of the HMD the real-world objects, and inertial sensor data from the, the gestures and movements of the user can be continuously monitored and tracked during the user’s interaction with the VR scenes. For example, while interacting with the scenes in the game, the user may make various gestures such as pointing and walking toward a particular content item in the scene. In one embodiment, the gestures can be tracked and processed by the system to generate a prediction of interaction with the particular content item in the game scene. In some embodiments, machine learning may be used to facilitate or assist in said prediction. During HMD use, various kinds of single-handed, as well as two-handed controllers can be used. In some implementations, the controllers themselves can be tracked by tracking lights included in the controllers, or tracking of shapes, sensors, and inertial data associated with the controllers. Using these various types of controllers, or even simply hand gestures that are made and captured by one or more cameras, it is possible to interface, control, maneuver, interact with, and participate in the virtual reality environment or metaverse rendered on an HMD. In some cases, the HMD can be wirelessly connected to a cloud computing and gaming system over a network. In one embodiment, the cloud computing and gaming system maintains and executes the video game being played by the user. In some embodiments, the cloud computing and gaming system is configured to receive inputs from the HMD and the interface objects over the network. The cloud computing and gaming system is configured to process the inputs to affect the game state of the executing video game. The output from the executing video game, such as video data, audio data, and haptic feedback data, is transmitted to the HMD and the interface objects. In other implementations, the HMD may communicate with the cloud computing and gaming system wirelessly through alternative mechanisms or channels such as a cellular network.

Additionally, though implementations in the present disclosure may be described with reference to a head-mounted display, it will be appreciated that in other implementations, non-head mounted displays may be substituted, including without limitation, portable device screens (e.g. tablet, smartphone, laptop, etc.) or any other type of display that can be configured to render video and/or provide for display of an interactive scene or virtual environment in accordance with the present implementations. It should be understood that the various embodiments defined herein may be combined or assembled into specific implementations using the various features disclosed herein. Thus, the examples provided are just some possible examples, without limitation to the various implementations that are possible by combining the various elements to define many more implementations. In some examples, some implementations may include fewer elements, without departing from the spirit of the disclosed or equivalent implementations.

Embodiments of the present disclosure may be practiced with various computer system configurations including hand-held devices, microprocessor systems, microprocessor-based or programmable consumer electronics, minicomputers, mainframe computers and the like. Embodiments of the present disclosure can also be practiced in distributed computing environments where tasks are performed by remote processing devices that are linked through a wire-based or wireless network.

Although the method operations were described in a specific order, it should be understood that other housekeeping operations may be performed in between operations, or operations may be adjusted so that they occur at slightly different times or may be distributed in a system which allows the occurrence of the processing operations at various intervals associated with the processing, as long as the processing of the telemetry and game state data for generating modified game states and are performed in the desired way.

One or more embodiments can also be fabricated as computer readable code on a computer readable medium. The computer readable medium is any data storage device that can store data, which can be thereafter be read by a computer system. Examples of the computer readable medium include hard drives, network attached storage (NAS), read-only memory, random-access memory, CD-ROMs, CD-Rs, CD-RWs, magnetic tapes and other optical and non-optical data storage devices. The computer readable medium can include computer readable tangible medium distributed over a network-coupled computer system so that the computer readable code is stored and executed in a distributed fashion.

In one embodiment, the video game is executed either locally on a gaming machine, a personal computer, or on a server. In some cases, the video game is executed by one or more servers of a data center. When the video game is executed, some instances of the video game may be a simulation of the video game. For example, the video game may be executed by an environment or server that generates a simulation of the video game. The simulation, on some embodiments, is an instance of the video game. In other embodiments, the simulation maybe produced by an emulator. In either case, if the video game is represented as a simulation, that simulation is capable of being executed to render interactive content that can be interactively streamed, executed, and/or controlled by user input.

Although the foregoing embodiments have been described in some detail for purposes of clarity of understanding, it will be apparent that certain changes and modifications can be practiced within the scope of the appended claims. Accordingly, the present embodiments are to be considered as illustrative and not restrictive, and the embodiments are not to be limited to the details given herein, but may be modified within the scope and equivalents of the appended claims.

1. A method for providing suggestions for gameplay to a user, comprising:
receiving a request from the user, the request identifying an intent the user is seeking during the gameplay and a time frame available for achieving the intent;
analyzing gameplay history maintained for the user to obtain details of gameplay for each video game of a plurality of video games played by the user over time, the gameplay history tracking progress of each task occurring within and providing a current game state of said each video game, wherein said each task is associated with a distinct intent;
forwarding select ones of video games from the plurality of video games played by the user for rendering on a user interface of a display screen of a client device for selection by the user, each video game of the select ones of the video games identified by matching the intent with an associated task for accomplishing the intent; and
detecting the selection of a video game from the select ones of the video games presented at the user interface, the detection resulting in an instance of the video game being made available to the user for the time frame specified in the request to allow the user to resume gameplay and progress in the associated task within the video game to accomplish the intent,
wherein operations of the method are performed by a recommendation generator executing on a server computing device communicatively coupled to the client device.

2. The method of claim 1, wherein said each video game of the select ones of the video games is identified based on current status of said associated task matching the intent, the current status determined from current game state of said each video game, and wherein said each video game is prioritized based on recency of gameplay of said video game.

3. The method of claim 1, wherein said task of said each video game of the select ones of the video games is an incomplete task or a partially completed task that was initiated by the user during a prior gameplay session, and the gameplay history is used to evaluate an amount of said task left to be completed.

4. The method of claim 1, wherein said task of said each video game of the select ones of the video games is assigned a weight to correspond with an amount of said task that remains to be completed or a recency of gameplay of said each video game, the amount determined by querying game logic of said each video game and by comparing current status of said task obtained from gameplay history maintained for said each video game with information obtained from the game logic.

5. The method of claim 4, wherein said each video game of said select ones of the video games is presented for rendering in accordance to the weight assigned to said associated task that corresponds with the intent identified in the request.

6. The method of claim 1, wherein analyzing the gameplay history further includes,
examining a storyline of said each video game of the plurality of video games played by the user to identify a plurality of tasks occurring in different portions of said each video game, wherein each task of the plurality of tasks corresponds with a distinct intent, the storyline used to match the intent expressed in the request to said associated task in said each video game.

7. The method of claim 1, wherein matching the intent with the associated task in each video game of the select ones of the video games includes,
querying a user profile of the user to identify gameplay attributes of the user, the gameplay attributes providing details of gameplay skills exhibited by the user for said each video game during prior gameplay sessions, and identifying said each video game by determining likelihood of the user in completing the task in said each video game within the time frame based on the gameplay skills exhibited by the user in said each video game.

8. The method of claim 7, wherein the gameplay skills possessed by the user in said each video game of the plurality of video games is dependent on complexity of inputs defined for said each video game, the gameplay skills identifying an expertise level of the user in said each video game.

9. The method of claim 1, wherein starting gameplay of the video game selected includes resuming said associated task matching the intent from a point where the user left off during a prior gameplay session of the video game.

10. The method of claim 1, further includes monitoring the gameplay of the user for the video game selected to accomplish the intent and providing updates of the gameplay of the video game to the user.

11. The method of claim 10, wherein providing the updates includes identifying and providing at least one alternate video game with an alternate task to complete to accomplish the intent, when an amount of progress made within the video game selected is below a predefined level, wherein the alternate task of the alternate video game is associated with an alternate intent that corresponds with or is similar to the intent expressed in the request.

12. The method of claim 11, wherein user selection of the alternate video game resulting in pausing the video game selected for gameplay by the user, and switching the user to the selected alternate video game for gameplay, the switching allowing the user to resume gameplay of the alternate video game from a resumption point identified from a corresponding prior gameplay session and complete the alternate task.

13. The method of claim 10, wherein providing the updates includes providing a count-down timer to provide a visual of progress made in completing the associated task within the video game selected by the user.

14. The method of claim 1,. said task identified in at least one of the select ones of the video games includes a new task not yet initiated by the user in a prior gameplay session, the new task is a subsequent task the user has to initiate during the gameplay of said at least one of the select ones of the video games and wherein the new task corresponds with the intent.

15. The method of claim 1, wherein matching the intent with the corresponding task within the video game selected from the select ones of the video games includes, determining a percentage of completion of a portion of said task corresponding to the intent in the video game; querying a user profile of the user to determine an amount of time taken to complete the percentage of said task; and evaluating an estimated amount of time required to accomplish remaining portion of said task, the estimated amount of time used to match with the time frame provided in the request.

16. A method for providing suggestions for gameplay to a user, comprising:
receiving a request from the user, the request expressing an intent the user is seeking during gameplay;
identifying select ones of a plurality of video games played by the user over time, the select ones identified to include a task that matches with the intent expressed by the user; presenting the select ones of the plurality of video games for user selection for gameplay in order to achieve the intent;
responsive to selection of a video game from the select ones of the plurality of video games, assigning an instance of the video game for gameplay by the user, the instance of the video game set to resume gameplay from the task associated with the intent, the gameplay of the user is monitored and progress made in the video game during gameplay is updated to gameplay history maintained for the user, wherein operations of the method are performed by a recommendation generator executing on a server computing device communicatively coupled to a client device of the user used to generate the request.

17. The method of claim 16, wherein the select ones of the plurality of video games are provided in a list, the list prioritized in accordance to one or more of amount of task left in each of the select ones of the video games, amount of time needed to complete the task, recency of gameplay of said each video game, availability of the instance of the video game, and user preference of the video game.

18. The method of claim 16, wherein the task used to identify each video game of the select ones of the video games is one that was previously started and not completed or is one that is defined to start at a resumption point where said each video game was paused by the user during prior gameplay.

19. The method of claim 16, wherein identifying the select ones of the plurality of video games further includes, analyzing the gameplay history maintained for the user to obtain details of gameplay for each video game of the plurality of video games played by the user over time, the gameplay history tracking progress of each task occurring within and providing a current game state of said each video game, wherein said each task is associated with a distinct intent.

20. The method of claim 19, wherein analyzing the gameplay history further includes,
examining a storyline of said each video game of the plurality of video games played by the user to identify a plurality of tasks occurring in different portions of said each video game, the storyline used to match the intent expressed in the request to the associated task in said each video game.
